(19) United States
(12) Patent Application Publication
(10) Pub. No.: US 2020/0085035 A1
(43) Pub. Date: Mar. 19, 2020

(54) GAME CALLING DEVICE

(71) Applicant: Jansen Michael Walls, Hillsville, VA (US)

(72) Inventor: Jansen Michael Walls, Hillsville, VA (US)

(21) Appl. No.: 16/437,474

(22) Filed: Jun. 11, 2019

Related U.S. Application Data
(60) Provisional application No. 62/730,807, filed on Sep. 13, 2018.

(51) Int. Cl. A01M 31/00

(52) U.S. Cl. CPC A01M 31/004

(57) ABSTRACT

A game calling device includes a flexible cover defining a cavity, and a plurality of components within the cavity. Each of the components is comprised of a polymeric material and includes a frusto-conical outer surface and a frusto-conical inner surface. The game calling device improves upon the prior art by producing a more realistic simulation of two deer sparring when the components are manipulated inside the bag.

### CROSS-REFERENCE TO RELATED APPLICATION

This application claims the benefit of U.S. Provisional Patent application No. 62/730,807, filed Sep. 13, 2018, and which is hereby incorporated by reference in its entirety.

### BACKGROUND OF THE INVENTION

A method of attracting antler-bearing animals includes reproducing the sound of antlers striking each other to simulate the sound of two animals sparring. For example, a hunter may hold an antler in each hand and manually strike one antler against the other antler to produce a sound that is attractive to deer. Some devices, known as “rattle bags,” include wooden rods in a cloth bag. By shaking or striking the bag, the rods strike each other to generate a clacking sound. Rattle bags are convenient to carry and use, but the sound produced by these devices does not accurately simulate the actual sound two deer sparring.

### SUMMARY

A game calling device includes a flexible cover defining a cavity, and a plurality of components within the cavity. Each of the components is comprised of a polymeric material and includes a frusto-conical outer surface and a frusto-conical inner surface. The game calling device improves upon the prior art by producing a more realistic simulation of two deer sparring when the components are manipulated inside the bag. Furthermore, the components are not subject to material degradation over time, unlike wood or antlers found in the prior art.

A corresponding method is also provided.

### BRIEF DESCRIPTION OF THE DRAWINGS

FIG. 1 is a schematic, side view of a game calling device having artificial antler components;

FIG. 2 is a schematic, cross-sectional, top view of the game calling device of FIG. 1;

FIG. 3 is a schematic, side view of one of the artificial antler components;

FIG. 4 is a schematic, top view of the artificial antler component of FIG. 3;

FIG. 5 is a schematic, bottom view of the artificial antler component of FIG. 3; and

FIG. 6 is a schematic, side view of the game calling device mounted to a firearm.

### DESCRIPTION OF THE PREFERRED EMBODIMENTS

Referring to the Figures, wherein like reference numbers refer to like components throughout, a game calling device 10 is schematically depicted. The game calling device 10 includes a cover 14. The cover 14 in the embodiment depicted is comprised of cloth or fabric, though any sufficiently flexible material may be employed within the scope of the claimed invention. The cloth or fabric may include fibers comprised of cotton, polyester, nylon, etc. The cover 14 defines a cavity 16. In the embodiment depicted, the cover 14 is a bag defining an opening 18 to the cavity 16. A drawstring 20 is mounted to the cover 14 such that the drawstring 20 surrounds the opening 18. The drawstring 20 is operative to selectively reduce the size of the opening 18 in a manner that is understood by those skilled in the art. Other closure systems may be employed within the scope of the claimed invention to close the opening 18 and thereby retain components of the game calling device 10 within the cavity 16 of the cover 14.

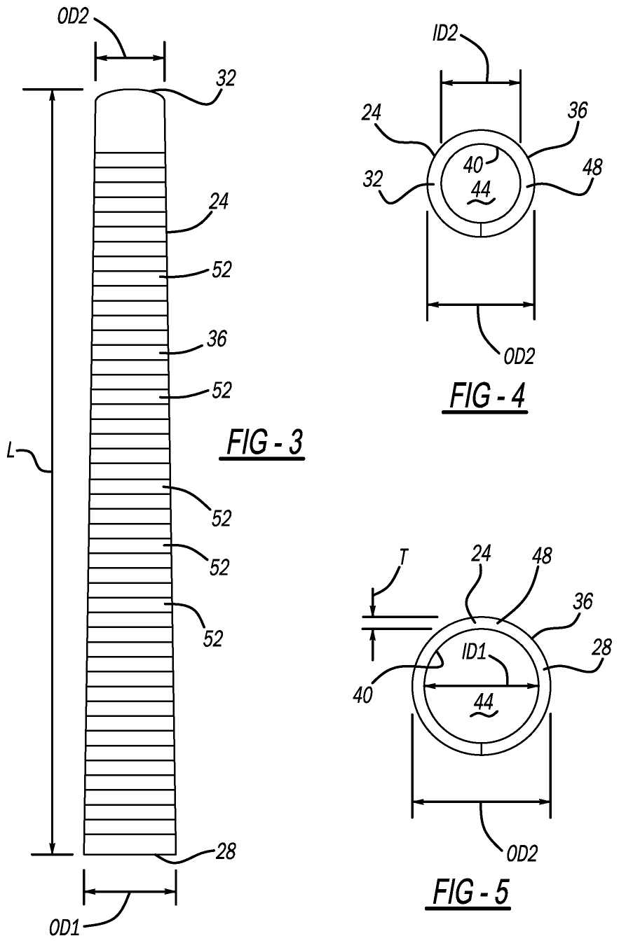

The device 10 includes a plurality of artificial antler components 24. The components 24 are disposed within the cavity 16 of the cover 14. FIGS. 3-5 schematically depict one of the components 24. Each of the components 24 is substantially identical to the one shown in FIGS. 3-5. The geometry and material of the components 24 enable the device 10 to produce a realistic and authentic replication of the sound of deer antlers striking one another, which occurs when deer are sparring, and which attracts other deer. Referring specifically to FIGS. 3-5, component 24 extends from a first end 28 to a second end 32. The component 24 defines an outer surface 36 and an inner surface 40. Component 24 is frusto-conical in shape, i.e., forms the frustum of a cone. Accordingly, the outer diameter of the component 24 tapers between the first end 28 and the second end 32.

The inner surface 40 defines a hole 44 that extends longitudinally through the component 24 from the first end 28 to the second end 32, and thus the component 24 is hollow. The hole 44 is frusto-conical in shape, i.e., the inner diameter of the component 24, i.e., the diameter of the hole 44, tapers between the first end 28 and the second end 32.

In the embodiment depicted, the length L of the component 24 is between 220 and 280 millimeters, and more preferably between 250 and 270 millimeters, and even more preferably between 255 and 265 millimeters. The outer diameter OD1 of the component 24 at the first end 28 is between 24 and 36 millimeters, and more preferably between 28 and 32 millimeters, and even more preferably 30 millimeters. The inner diameter ID1 of the component 24 at the first end 28 is between 19 and 29 millimeters, and preferably between 22 and 26 millimeters, and even more preferably 24 millimeters.

The outer diameter OD2 of the component 24 at the second end 32 is between 18 and 28 millimeters, and more preferably between 21 and 25 millimeters, and even more preferably 23 millimeters. The inner diameter ID2 of the component 24 at the second end 32 is between 14 and 21 millimeters, and preferably between 16 and 18 millimeters, and even more preferably 17 millimeters.

In the embodiment depicted, the length L is 260 millimeters, the outer diameter OD1 at the first end 28 is 30 millimeters, the outer diameter OD2 at the second end 32 is 23 millimeters, the inner diameter ID1 at the first end 28 is 24 millimeters, and the inner diameter ID2 at the second end 32 is 17 millimeters.

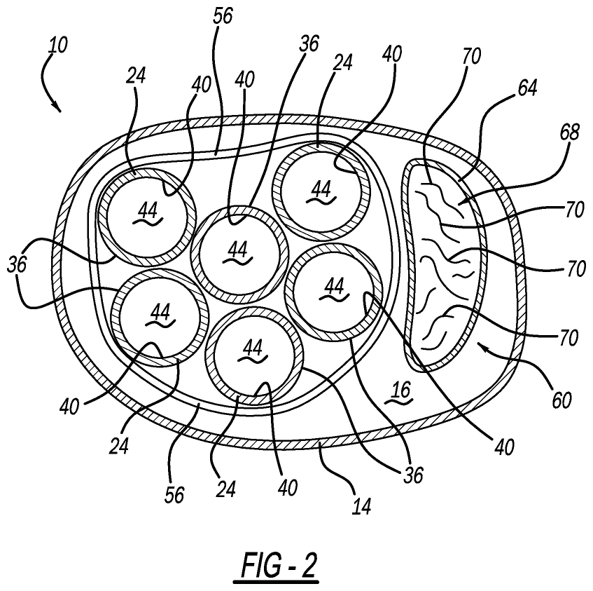

As best seen in FIGS. 4 and 5, the thickness T of the wall 48 formed between the inner surface 40 and the outer surface 36 does not substantially vary along either the length of the component 24 or around the circumference of the component 24. The thickness T in one embodiment is 2-4 millimeters, and is preferably 3 millimeters. Accordingly, the components 24 have an annular cross-sectional shape, as shown in FIG. 2.

The outer surface 36 is characterized by a series of alternating annular ridges and/or grooves 52 that extend around the circumference of the component 24, as best shown in FIG. 3. The components 24 in the embodiment depicted are comprised of a polymeric material, such as polycarbonate, acrylonitrile butadiene styrene (ABS), or polypropylene. The combination of geometry and material described herein has been found to provide superior simulation of rattling antlers, and is thus more attractive to deer than prior art rattle bag systems.

Referring to FIG. 2, the device 10 includes six components 24 within the cavity 16 of the cover 14, though more or fewer components 24 may be employed within the scope of the claimed invention. The device 10 includes a rubber band 56 or other elastic material that surrounds all of the components 24 to keep the components 24 in contact or close proximity to one another.

The device 10 also includes a system 60 for simulating the sound of deer moving on the ground. In the embodiment shown, the system 60 includes a tube-like container 64 comprised of a polymeric fabric material, such as nylon. In one embodiment, the container 64 is made of the same material as that commonly used to manufacture pantyhose. The container 64 defines a cavity 68 containing crinkle paper 70. In one embodiment, the crinkle paper 70 comprises at least one of cellophane, wax paper, polyethylene, and polyvinyl chloride. The system 60, including the container 64 containing the crinkle paper 70, is disposed within the cavity 16 of the cover 14 and is adjacent to the components 24.

To use the device 10, the device is shaken or manipulated, i.e., various forces are exerted on the exterior of the cover 14, to cause relative motion between the components 24. As the components 24 contact and move relative to one another, they produce a sound that simulates deer sparring with their antlers. The crinkle paper 70 is also deformed and produces a sound that is similar to the sound of leaves or other forest matter being stepped upon by sparring deer.

It should be noted that the system 60 may have other configurations within the scope of the claimed invention. For example, and without limitation, the crinkle paper 70 may be placed directly in the cavity 16 without the container 64, or the crinkle paper 70 may be placed in a pocket formed in the cover 14 adjacent the cavity 16.

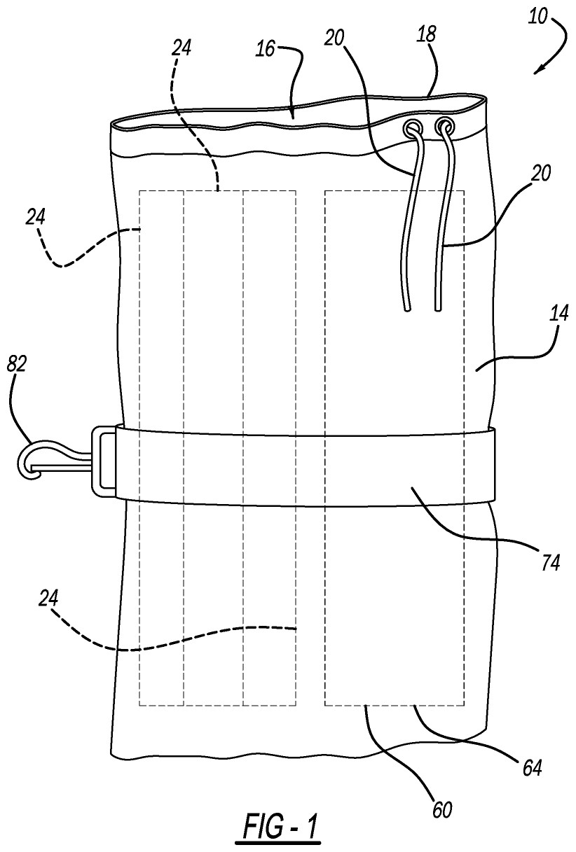

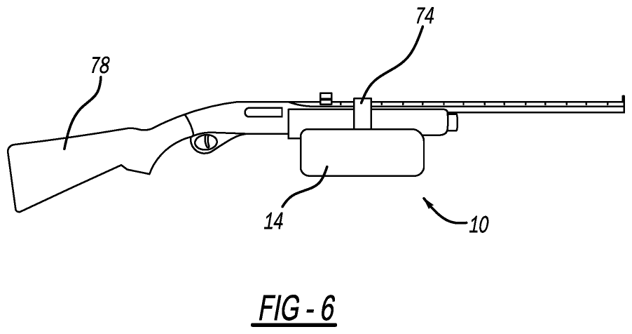

Referring specifically to FIG. 1, the device 10 further includes a strap 74 that circumscribes the exterior of the cover 14. The strap 74 enables the attachment of the device to a weapon, such as the firearm shown at 78 in FIG. 6. Referring to FIG. 6, the stock and barrel of the firearm 78 extend between the cover 14 and the strap 74 to secure the device 10 to the firearm 78. Referring again to FIG. 1, a hook 82 is attached to the strap 74. The hook 82 may be used to attach a spring reel, bow rope, etc. to use at ground level. In one embodiment, the strap 74 is attached to the cover 14 and includes at least some elastomeric material to enhance elasticity.

While the best modes for carrying out the invention have been described in detail, those familiar with the art to which this invention relates will recognize various alternative designs and embodiments for practicing the invention within the scope of the appended claims.

1. A game calling device comprising:
a cover defining a cavity; and
a plurality of components within the cavity;
wherein each of said components is comprised of a polymeric material and includes a frusto-conical outer surface and a frusto-conical inner surface.

2. The game calling device of claim 1, wherein each of said components has a respective first end and a respective second end;
wherein the length of each component is between 220 and 280 millimeters;
wherein the inner diameter of each component at the first end is between 19 and 29 millimeters;
wherein the outer diameter of each component at the first end is between 24 and 36 millimeters;
wherein the inner diameter of each component at the second end is between 14 and 21 millimeters; and
wherein the outer diameter of each component at the second end is between 18 and 28 millimeters.

3. The game calling device of claim 2, wherein the length of each component is between 250 and 270 millimeters;
wherein the inner diameter at the first end is between 22 and 26 millimeters;
wherein the outer diameter at the first end is between 28 and 32 millimeters;
wherein the inner diameter at the second end is between 16 and 18 millimeters; and
wherein the outer diameter at the second end is between 21 and 25 millimeters.

4. The game calling device of claim 1, wherein the polymeric material is one of polycarbonate, acrylonitrile butadiene styrene (ABS), and polypropylene.

5. The game calling device of claim 1, further comprising crinkle paper operatively connected to the cover.

6. The game calling device of claim 6, wherein the crinkle paper is within the cavity.

7. The game calling device of claim 7, wherein the crinkle paper comprises at least one of cellophane, wax paper, polyethylene, and polyvinyl chloride.

8. The game calling device of claim 1, wherein the outer surfaces are characterized by alternating ridges or grooves.

9. A method for calling game, the method comprising:
possessing a game calling device having a cover defining a cavity, and a plurality of components within the cavity, each of the components being comprised of a polymeric material and including a frusto-conical outer surface and a frusto-conical inner surface; and
shaking or manipulating the cover to cause movement of the components relative to one another.

10. The method of claim 9, wherein each of said components has a respective first end and a respective second end;
wherein the length of each component is between 220 and 280 millimeters;
wherein the inner diameter of each component at the first end is between 19 and 29 millimeters;
wherein the outer diameter of each component at the first end is between 24 and 36 millimeters;
wherein the inner diameter of each component at the second end is between 14 and 21 millimeters; and
wherein the outer diameter of each component at the second end is between 18 and 28 millimeters.

11. The method of claim 10, wherein the game calling device also includes crinkle paper positioned such that said shaking or manipulating of the cover also causes deformation of the crinkle paper.
